(19) United States
(12) Patent Application Publication
(10) Pub. No.: US 2008/0315781 A1
(43) Pub. Date: Dec. 25, 2008

(54) DISCHARGE LAMP LIGHT-UP CONTROL APPARATUS AND POWER CIRCUIT

(75) Inventors: Tetsuro IKEDA, Osaka (JP); Kenzo DANJO, Osaka (JP); Hiroki MORIMOTO, Osaka (JP)

Correspondence Address: GLOBAL IP COUNSELORS, LLP, 1233 20TH STREET, NW, SUITE 700, WASHINGTON, DC, 20036-2680, US

(73) Assignee: SANSHA ELECTRIC MANUFACTURING CO., LTD., Osaka (JP)

(21) Appl. No.: 12/141,315

(22) Filed: Jun. 18, 2008

(30) Foreign Application Priority Data
Jun. 25, 2007 (JP) 2007-166902

(51) Int. Cl. H05B 37/02

(52) U.S. Cl. 315/224

(57) ABSTRACT

The present invention is directed to realize an optimum lamp control with an inexpensive configuration in a discharge lamp light-up control apparatus. A constant current control unit controls light-up of a discharge lamp by transmitting a control signal to an inverter and includes: a storage for storing lamp characteristics of the discharge lamp; and a CPU for obtaining information indicative of a type of the discharge lamp attached, reading the lamp characteristics from the storage based on the obtained type information, and transmitting a control signal to the inverter so that an output corresponding to the read lamp characteristics are obtained.

### BACKGROUND OF THE INVENTION

1. Field of the Invention

The present invention relates to a discharge lamp light-up control apparatus and, more particularly, to a discharge lamp light-up control apparatus for performing a constant current control prior to a constant power control.

2. Description of the Background Art

A discharge lamp is classified to a low-pressure discharge lamp and a high-pressure discharge lamp in accordance with the pressure of discharge gas. The high-pressure discharge lamp is further classified into a xenon lamp, a high-pressure mercury lamp, a halide lamp, and the like. A metal halide lamp is a high-pressure discharge lamp obtained by adding various metallic halides into high vapor pressure mercury discharge.

As a method of controlling light-up of the discharge lamps, generally, constant power control is performed to suppress increase in power consumption at the time of light-on in a stable state. On the other hand, in a high-pressure discharge lamp such as a metal halide lamp, light-up voltage is low for a few minutes after an electrical breakdown. Consequently, in the period, constant current control is performed. That is, the constant current control is performed first. After the voltage reaches a predetermined value, the constant power control is performed.

A power supply unit for supplying power to a discharge lamp mainly has a lamp drive circuit (inverter) and a discharge lamp light-up control apparatus for performing feedback control.

As a light-up condition of a discharge lamp, the current value and the control characteristics at the time of start-up have to be properly selected according to the rating of the discharge lamp. If the selection is improper, it causes deterioration in a lamp electrode, and the life of the lamp may be shortened.

A discharge lamp light-up control apparatus using a lamp unit having a memory in a lamp in order to address the problem is known (refer to, for example, Japanese Unexamined Patent Publication No. 2002-341442). In the apparatus, when the lamp unit is attached to a high-pressure discharge lighting apparatus, a controller reads optimum light-up conditions (such as rated wattage, a changeable wattage range, proper light-up frequency, a correction value for a circuit loss, and the like) stored in the memory in the lamp unit, and controls a lamp drive circuit based on the read data. The controller stores light-up conditions (light-up time and voltage/current value) of the driven lamp. When a next lamp light-up instruction is received, the controller calls the normal/abnormal light-up state of last time and accumulated light-up time and performs a control. In such a manner, a plurality of types of lamps can be attached to a power supply unit.

In the conventional discharge lamp light-up control apparatus, a lamp is changed in each of lamp units, so that memories storing the optimum light-on conditions of the number corresponding to a plurality of lamps have to be prepared. Therefore, the cost of the lamp unit rises and the cost of the apparatus as a whole also rises.

### SUMMARY OF THE INVENTION

An object of the present invention is to realize optimum lamp control with an inexpensive configuration in a discharge lamp light-up control apparatus.

According to an aspect of the prevent invention, a discharge lamp light-up control apparatus for controlling light-up of a discharge lamp by transmitting a control signal to an inverter includes: a storage for storing lamp characteristics of the discharge lamp; and a control unit for obtaining information indicative of a type of the discharge lamp attached, reading the lamp characteristics from the storage based on the obtained type information, and transmitting a control signal to the inverter so that an output corresponding to the read lamp characteristics are obtained.

In the apparatus, the lamp characteristics can be controlled based on the information of a discharge lamp attached, so that a plurality of lamps can be used safely. As a result, the life of the lamp can be maintained. In particular, the discharge lamp does not have to have storing means, so that an inexpensive configuration can be realized.

Preferably, the control unit transmits a control signal to the inverter to make the inverter perform constant current control and constant power control.

In the apparatus, the inverter can be made perform the constant current control and the constant power control.

Preferably, the lamp characteristics include both a power value in the constant power control and the minimum current value for generating an arc.

In the apparatus, the inverter can be controlled so as to light on the discharge lamp under the optimum light-up conditions.

Preferably, the constant current control includes a first constant current control and a second constant current control for outputting a current value larger than a current value in the first constant current control.

In the apparatus, the first constant current control is executed prior to the second constant current control, so that the temperature of the electrodes can be prevented from sharply rising at the time of start-up. As a result, the life of the discharge lamp can be increased.

Preferably, the current value in the first constant current control is equivalent to the minimum current value for generating an arc.

In the apparatus, in a first constant current control step, an arc is generated reliably without sharply increasing the temperature of the electrodes at the time of start-up.

Preferably, the constant current control further includes, between the first and second constant current controls, a current change control for increasing a current.

In the apparatus, the electrodes are gradually warmed, so that the temperature of the electrodes does not rise instantaneously. Consequently, the life of the lamp can be increased.

A power circuit according to another aspect of the present invention includes an inverter and the above-described discharge lamp light-up control apparatus capable of controlling the inverter.

In the apparatus, the lamp characteristics can be controlled based on information of the discharge lamp attached. Therefore, a plurality of lamps can be used safely and, as a result, the life of the lamp can be maintained. In particular, the discharge lamp does not have to have storing means, so that an inexpensive configuration is realized.

In the discharge lamp light-up control apparatus and the power circuit according to the present invention, the lamp characteristics can be controlled based on the information of the discharge lamp attached. Consequently, a plurality of lamps can be used safely and, as a result, the life of the lamp can be maintained. In particular, the discharge lamp does not have to have storing means, so that an inexpensive configuration is realized.

### BRIEF DESCRIPTION OF THE DRAWINGS

FIG. 1 is a circuit block diagram of a power supply for a light source as an embodiment of the present invention;

FIG. 2 is constant power characteristics (current-voltage characteristics) diagram by ratings of a discharge lamp;

FIG. 3 is a flowchart showing discharge lamp light-on control operation as an embodiment of the invention; and

FIG. 4 is a graph showing the discharge lamp light-up control operation as an embodiment of the invention and showing changes in lamp current using time as a parameter.

### DETAILED DESCRIPTION OF PREFERRED EMBODIMENTS

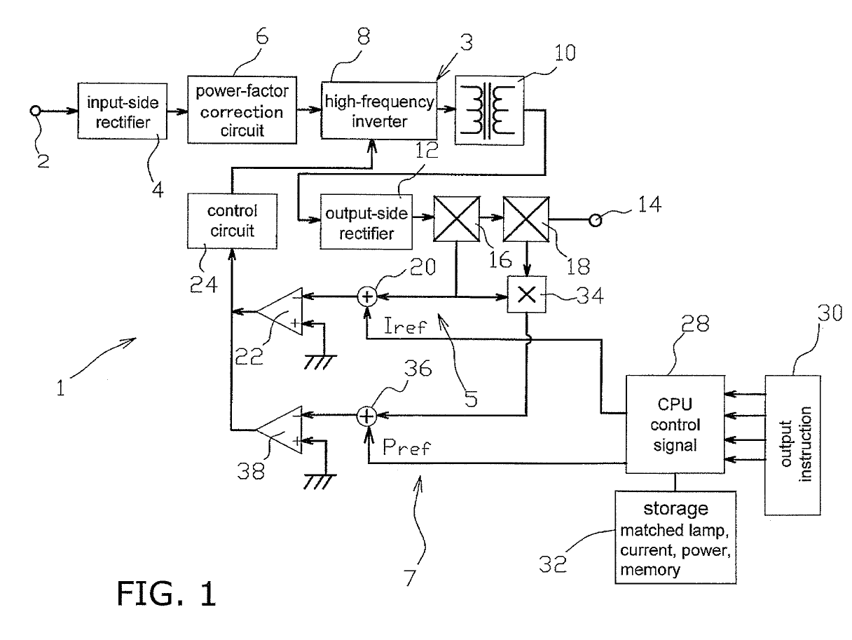

FIG. 1 shows a power supply unit 1 as an embodiment of the present invention. The power supply unit 1 controls light-up of a high-pressure discharge lamp such as a metal halide lamp. The power supply unit 1 has an input terminal 2 to which AC voltage is supplied from a commercial AC power source, and an output terminal 14 for outputting DC voltage to a discharge lamp (not shown). Between the input terminal 2 and the output terminal 14, an input-side rectifier 4, a power-factor correction circuit 6, a high-frequency inverter 8, a transformer 10, and an output-side rectifier 12 are disposed in order.

The input-side rectifier 4 is a circuit for converting the AC voltage to DC voltage by rectifying and smoothing the AC voltage.

The high-frequency inverter 8 is a DC-RF converter for converting DC voltage to high-frequency voltage. The high-frequency inverter 8 has a plurality of semiconductor switching devices (for example, IGBTs, power FETs, or bipolar transistors). The semiconductor switching devices turn on/off repeatedly at high speed in response to control signals from a control circuit 24 which will be described later, thereby converting a DC signal to a high-frequency signal. The transformer 10 decreases the input high-frequency voltage to a predetermined high-frequency voltage. The output-side rectifier 12 is an RF-DC converter for converting high-frequency voltage to DC voltage. The high-frequency inverter 8, the transformer 10, and the output-side rectifier 12 function as a direct current to direct current (DC-DC) converter 3.

Next, a current control unit 5 for controlling the operation of the high-frequency inverter 8 will be described. The current control unit 5 has a current detector 16, a first adder 20, a first error amplifier 22, the control circuit 24, a CPU 28, and a storage means 32.

The current detector 16 is connected between the output-side rectifier 12 and the output terminal 14. The current detector 16 generates a load current detection signal (for example, a load current detection voltage) indicative of direct current (load current) which is supplied from the output-side rectifier 12 to the discharge lamp. The load current detection voltage from the current detector 16 is supplied to the first adder 20. To the first adder 20, a reference voltage from the CPU 28 is also supplied. The CPU 28 reads a current value of each of lamps in each of periods T1, T2, and T3 stored in the storage 32 and supplies the reference voltage to the first adder 20. The first adder 20 calculates the difference between the load current detection voltage and the reference voltage and supplies the difference to the first error amplifier 22. The difference is supplied to a negative input terminal of the first error amplifier 22, and a positive input terminal of the first error amplifier 22 is installed in a reference potential point, for example, an earth potential point. Therefore, an output signal (for example, output voltage) of the first error amplifier 22 is a signal obtained by inverting the sign of the output voltage of the first adder 20.

The first error amplifier 22 supplies the output voltage to the control circuit 24. The control circuit 24 controls the conduction period of the semiconductor switching devices of the high-frequency inverter 8 so that the input voltage of the first error amplifier 22 becomes zero, that is, the load current detection voltage of the current detector 16 becomes equal to the reference voltage from the CPU 28.

Further, a constant power control unit 7 for controlling operation of the high-frequency inverter 8 will be described. The constant power control unit 7 includes the current detector 16 (described above), a voltage detector 18, a multiplier 34, a second adder 36, a second error amplifier 38, the control circuit 24 (described above), the CPU 28 (described above), and an output instruction generator 30.

The voltage detector 18 is connected between the output-side rectifier 12 and the output terminal 14. The voltage detector 18 generates a load voltage detection signal (for example, load voltage detection voltage) indicative of a DC voltage (load voltage) supplied from the output-side rectifier 12 to the discharge lamp. The load voltage detection voltage from the voltage detector 18 is supplied to the multiplier 34. The load current detection voltage from the current detector 16 is also supplied to the multiplier 34. The multiplier 34 multiplies the voltage values with each other to calculate a load power display signal (for example, load power display voltage) indicative of load power and supplies it to the second adder 36. To the second adder 36, a constant power reference voltage as a lamp constant power reference signal is also supplied from the CPU 28. The CPU 28 supplies the reference voltage to the second adder 36 in accordance with an instruction from the output instruction generator 30. The second adder 36 calculates the difference between the load power display voltage and the reference voltage and supplies it to the second error amplifier 38. The difference is supplied to a load input terminal of the second error amplifier 38, and a positive input terminal of the second error amplifier 38 is installed in a reference potential point, for example, an earth potential point. Therefore, an output signal (for example, output voltage) of the second error amplifier 38 is a signal obtained by inverting the sign of the output voltage of the second adder 36.

The second error amplifier 38 supplies the output voltage to the control circuit 24. The control circuit 24 controls the conduction period of the semiconductor switching devices of the high-frequency inverter 8 so that the input voltage of the second error amplifier 38 becomes zero, that is, the load power detection voltage from the multiplier 34 becomes equal to the constant power reference voltage from the CPU 28.

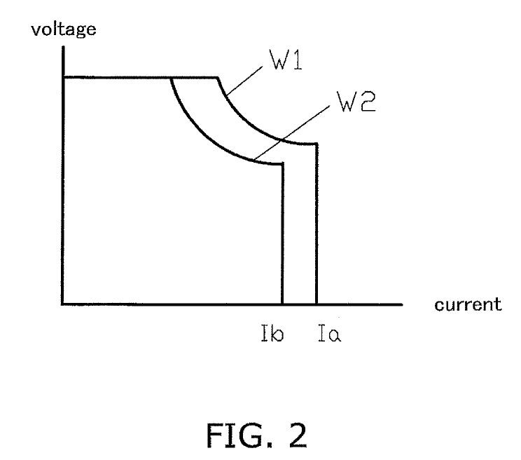

FIG. 2 is a graph showing the lamp characteristics (the relation between current and voltage) of each of discharge lamps. Ia and Ib denote constant current values, and W1 and W2 denote constant power values.

As described above, the power supply unit 1 controls light-up of a high-pressure discharge lamp such as a metal halide lamp. Concretely, the power supply unit 1 performs light-on control in accordance with the order of the constant current control and the constant power control. The reason will be described below. A xenon lamp is constructed by, for example, disposing an anode and a cathode at an interval of a few millimeters in a glass tube, and filling the glass tube with xenon gas at a pressure of a few atmospheres. When constant current is passed across the anode and the cathode of the xenon lamp, arc discharge is generated between the tip of the anode and the tip of the cathode, and lighting in a stable state is performed after that. On the other hand, when the xenon lamp is used for long time and the lamp life is going to be finished, the anode and the cathode are worn, the air pressure in the glass tube drops, and the impedance of the xenon lamp increases. As a result, the voltage applied to the xenon lamp increases in an operation stable state. Due to this, the power consumption of the xenon lamp increases, that is, heat generation in the xenon lamp increases. There is consequently the possibility that the anode and the cathode melt. A technique is known such that when the voltage applied to the xenon lamp reaches a predetermined voltage value, the current flowing in the xenon lamp is reduced, thereby suppressing power consumption of the lamp. In particular, as a technique for reducing current flowing in a xenon lamp, a method of performing the constant power control when output voltage becomes equal to or higher than the reference voltage is known.

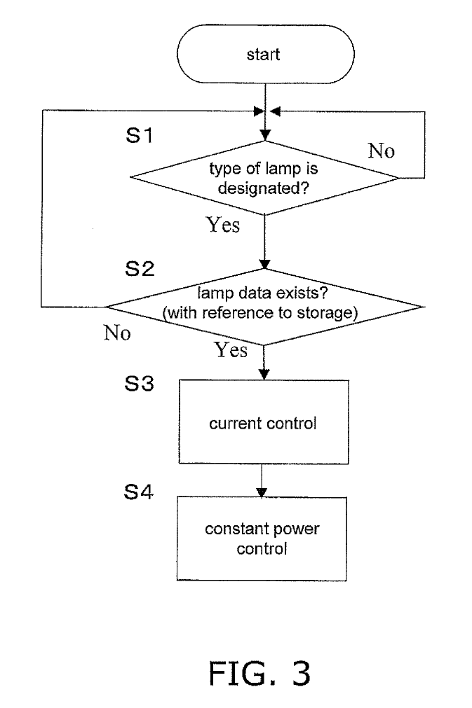

FIG. 3 is a flowchart for explaining discharge lamp controlling operation as an embodiment of the invention, which is performed by the CPU 28 and a program. Table 1 shows current reference values I_{ref} and power reference values P_{ref} in periods T1 to T4 (which will be described later) of a lamp (having a constant power value of 1 kW) stored in the storage 32. The storage 32 stores similar information for each type of lamps.

TABLE 1

| | | T1 | T2 | T3 | T4 |
|---|---|---|---|---|---|
| type of | Iref | 25 A | 5 A/sec | 50 A | 50 A |
| lamp | Pref | 1 kW | 1 kW | 1 kW | 1 kW |
| 1 kW | | | | | |

The operator enters information specifying a discharge lamp attached (various information such as wattage and rating) with a not-shown input device. The information specifying a discharge lamp may be supplied via another device or network.

In step S1, a check is made to see whether the type of a lamp is specified or not. If it is specified, the program moves to step S2 where a check is made to see whether information related to the specified lamp is stored in the storage 32 or not with reference to the storage 32. If the information is not stored, for example, an error signal is output, and the program returns to the step S1. When the error signal is generated a plurality of times, the process may be finished. In the case where there is information related to the specified lamp, a constant power value is notified to the output instruction generator 30. The program moves to step S3 where current control (which will be described later) is performed. After that, the program moves to step S4 and constant power control is performed (which will be described later).

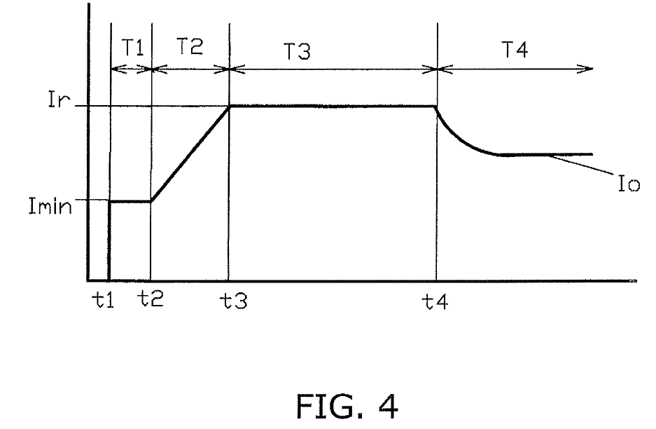

With reference to FIG. 4, the current control and the constant power control will be described. FIG. 4 is a graph for explaining changes with time of lamp current Io. The power supply unit 1 has a computer program including an instruction for making a computer execute the following discharge lamp control method.

The period T1 is a period from time t1 of breakdown to time t2 when the arc is stable. In the period T1, the CPU 28 supplies a reference voltage indicative of the reference current (for example, 25 A) in the period T1 read from the storage 32 to the first adder 20. The first adder 20 calculates the difference between the load current detection voltage and the reference voltage and supplies it to the first error amplifier 22. The first error amplifier 22 supplies output voltage to the control circuit 24. The control circuit 24 controls the conduction period of the semiconductor switching devices of the high frequency inverter 8 so that the load current detection voltage of the current detector 16 becomes equal to the reference voltage from the CPU 28.

The period T2 is a period in which the current value sloped up from t2. In the period T2, the CPU 28 supplies the reference voltage to the first adder 20 based on the increasing rate (for example, 5 A/sec) of the reference current in the period T2 read from the storage 32. The first adder 20 calculates the difference between the load current detection voltage and the reference voltage and supplies it to the first error amplifier 22. The first error amplifier 22 supplies the output voltage to the control circuit 24. The control circuit 24 controls the conduction period of the semiconductor switching devices of the high-frequency inverter 8 so that the load current detection voltage of the current detector 16 becomes equal to the reference voltage from the CPU 28. A period obtained by combining the periods T1 and T2 is defined as a start period.

The period T3 is a light-up start period from the arc stabilization time t3 to time t4 at which the light-up voltage of the lamp reaches a predetermined value. In the period T3, the CPU 28 supplies the reference voltage indicative of reference current (for example, 50 A) in the period T3 read from the storage 32 to the first adder 20. The first adder 20 calculates the difference between the load current detection voltage and the reference voltage and supplies it to the first error amplifier 22. The first error amplifier 22 supplies output voltage to the control circuit 24. The control circuit 24 controls the conduction period of the semiconductor switching devices of the high frequency inverter 8 so that the load current detection voltage of the current detector 16 becomes equal to the reference voltage from the CPU 28.

The period T4 is a state of the constant power control and a steady light-up period in which various discharge lamps can be used. In the period T4, the CPU 28 supplies the reference voltage (for example, a signal indicative of a constant power value of 1 kW) to the second adder 36 in accordance with an instruction from the output instruction generator 30. The second adder 36 calculates the difference between the load power display voltage and the reference voltage and supplies it to the second error amplifier 38. The second error amplifier 38 supplies the output voltage to the control circuit 24. The control circuit 24 controls the conduction period of the semiconductor switching devices of the high frequency inverter 8 so that the input voltage of the second error amplifier 38 becomes zero, that is, the load power display voltage from the multiplier 34 becomes equal to the constant power reference voltage from the CPU 28.

In FIG. 4, Imin denotes the minimum current value at which the arc is generated. Ir denotes the value of a reference current passed in the period T3 in which stability of voltage is waited.

As an example, when the reference current value Ir in the period T2 is 10 A, the reference current value Imin at the start is set to a small value as about 60 A. Consequently, even if overshooting occurs, there is no problem. In a lamp of 500 W, rated current of 33 A flows. In a lamp of 7 kW, rated current of 180 A flows. In any case, by satisfying Imin=0.6*Ir, a preferable result is obtained. The period T2 (t2 to t3) is about 10 seconds, and the period T3 (t3 to t4) lies in a range of five to 10 seconds. The period T1 (t1 to t2) lies in the range of one to two seconds.

The constant current control unit 5 controls light-up of a discharge lamp by transmitting a control signal to the inverter 8 and includes: the storage 32 for storing the lamp characteristics of the discharge lamp; and the CPU 28 for obtaining information indicative of the type of the discharge lamp attached, reading the lamp characteristics from the storage based on the obtained type information, and transmitting a control signal to the inverter 8 so that an output corresponding to the read lamp characteristics is obtained.

In the apparatus, the lamp characteristics can be controlled based on the information of the attached discharge lamp. Consequently, a plurality of lamps can be used safely and, as a result, the life of the lamps can be maintained. In particular, the discharge lamp does not have to have a storage means. Thus, an inexpensive configuration is realized.

Since the control unit transmits the control signal to the inverter to make the inverter perform the constant current control and the constant power control, the inverter can be made perform the constant current control and the constant power control.

Since the lamp characteristics include the power value in the constant power control and the minimum current value for generating an arc, the inverter can be controlled to light up the discharge lamp under the optimum light-on conditions.

The lamp characteristics are expressed as instruction values for transmitting the control signal. Further, each of the instruction values is designated by a combination of the voltage value in the constant voltage control and the minimum current value for generating an arc. Therefore, the inverter can be controlled so as to light on the discharge lamp under the optimum light-on conditions.

The constant current control includes the first constant current control and the second constant current control for outputting a current value larger than the current value in the first constant current control. Further, the first constant current control is executed prior to the second constant current control, so that the temperature of the electrodes can be prevented from sharply rising at the time of start-up. As a result, the life of the discharge lamp can be increased.

The current value in the first constant current control is equivalent to the minimum current value for generating an arc. Therefore, in the first constant current control step, an arc is generated reliably without sharply increasing the temperature of the electrodes at the time of start-up.

The constant current control further includes, between the first and second constant current controls, a current change control for increasing a current. The electrodes are gradually warmed, so that the temperature of the electrodes does not rise instantaneously.

### Other Embodiments

The foregoing embodiment is just an example of the present invention. The invention can be variously modified without departing from the gist of the invention.

What is claimed is:

1. A discharge lamp light-up control apparatus for controlling light-up of a discharge lamp by transmitting a control signal to an inverter, the apparatus comprising:
a storage for storing lamp characteristics of the discharge lamp; and
a control unit for obtaining information indicative of a type of the discharge lamp attached, reading the lamp characteristics from the storage based on the obtained type information, and transmitting a control signal to the inverter so that an output corresponding to the read lamp characteristics are obtained.

2. The discharge lamp light-up control apparatus according to claim 1, wherein the control unit transmits a control signal to the inverter to make the inverter perform a constant current control and a constant power control.

3. The discharge lamp light-up control apparatus according to claim 2, wherein the lamp characteristics include both a power value in the constant power control and a minimum current value for generating an arc.

4. The discharge lamp light-up control apparatus according to claim 3, wherein the constant current control includes a first constant current control and a second constant current control for outputting a current value larger than a current value in the first constant current control.

5. The discharge lamp light-up control apparatus according to claim 4, wherein the current value in the first constant current control is equivalent to the minimum current value for generating an arc.

6. The discharge lamp light-up control apparatus according to claim 5, wherein the constant current control further includes, between the first and second constant current controls, a current change control for increasing a current.

7. The discharge lamp light-up control apparatus according to claim 4, wherein the constant current control further includes, between the first and second constant current controls, a current change control for increasing a current.

8. The discharge lamp light-up control apparatus according to claim 2, wherein the constant current control includes a first constant current control and a second constant current control for outputting a current value larger than a current value in the first constant current control.

9. The discharge lamp light-up control apparatus according to claim 8, wherein the current value in the first constant current control is equivalent to a minimum current value for generating an arc.

10. The discharge lamp light-up control apparatus according to claim 9, wherein the constant current control further includes, between the first and second constant current controls, a current change control for increasing a current.

11. The discharge lamp light-up control apparatus according to claim 8, wherein the constant current control further includes, between the first and second constant current controls, a current change control for increasing a current.

12. A power circuit comprising:
an inverter; and
the discharge lamp light-up control apparatus according to claim 1, the apparatus being capable of controlling the inverter.
